(19) United States
(12) Patent Application Publication
(10) Pub. No.: US 2006/0113792 A1
(43) Pub. Date: Jun. 1, 2006

(54) Quick connector fluid coupling

(75) Inventor: Thomas Weithorn, Rochester, MI (US)

Correspondence Address: HARNESS, DICKEY & PIERCE, P.L.C., P.O. BOX 828, BLOOMFIELD HILLS, MI, 48303, US

(73) Assignee: Enhanced Applications, L.C., Troy, MI (US)

(21) Appl. No.: 11/272,519

(22) Filed: Nov. 11, 2005

Related U.S. Application Data
(60) Provisional application No. 60/627,800, filed on Nov. 12, 2004.

(51) Int. Cl. F16L 37/00

(52) U.S. Cl. 285/305

(57) ABSTRACT

A coupling for connecting fluid lines primarily for use in the automotive field comprised of a male end, a female end, and a one piece retaining element. The male end has an extending portion that is received in the female member and a conjoined attachment element made up of a one piece retaining ring with one or more leaf springs that engage with the female end upon connection. During engagement, the leaf springs are biased apart by a chamfer collar on the receiving end of the female member. The outward turned portion of the leaf springs provides a rounded edge for ease of engagement of the members, and has a means for manually releasing the connection simply by depressing a lever extension of the extended leaf arms. One or more O-ring seals are embodied to form a fluid tight connection, and once connected; the male and female members are swivelable.

### CROSS-REFERENCE TO RELATED APPLICATIONS

This application claims the benefit of U.S. Provisional Application No. 60/627,800, filed on Nov. 12, 2004.

### FIELD

This invention relates to fluid line couplings. Specifically, this invention relates to couplings for connecting fluid conduits, and which provides for a quick, releasable connection.

### BACKGROUND

The statements in this section merely provide background information related to the present disclosure and may not constitute prior art.

Quick connector couplings, which are relied upon heavily in the automotive industry, generally consist of a male member received by a female member, each of which are attached to separate fluid conduits. The two most difficult obstacles to overcome in creating such a connection are providing a fluid tight seal and a simple method of connection and disconnection. Prior methods of obtaining such a connection included threaded fittings which require tools to tighten, and very often the need to retighten on a regular basis, which potentially results in down-time for the vehicle.

With threaded fittings, there is also a risk involved of possibly over-tightening the connector, which could damage the coupling, causing possible leakage. A further drawback with the conventional type of fittings is that many times they may be difficult to align in the correct orientation while connecting the two members, possibly causing kinks in the fluid line which stresses the hose and shortens its life.

Other quick connector couplings known in the prior art often require special tools to release the connection once the two members are engaged, which can cause a problem if the coupling is located in a remote location such as the underside of a vehicle chassis or inside a crowded engine compartment.

A single piece attachment means is taught by Bonser, U.S. Pat. No. 5,711,553 in forming a connection between the male and female elements embodying an attachment window; however, such attachment means is not secured from sliding up and down the male member during connection, which may cause difficulty in securing connection in tight areas such as the engine compartment of a vehicle. Furthermore, the '553 invention is not releasable manually by extended lever portions of the attachment legs as the present invention discloses.

As a result of the aforesaid shortcomings of prior art connector designs, the need arose for a connector that can be fastened quickly, provide a fluid tight seal, and can be engaged or disengaged manually without any special tools. The use of a quick connector coupling is advantageous in that it can create a sealed and secured connection between fluid lines, with minimal effort and expense.

### SUMMARY

It is an object of the present invention to provide a quick connect coupling for fluids lines that is manually releasable, provides a fluid tight seal, and is economically manufactured.

It is also an object of the present invention to provide a secure connection by means of a retaining element on the male member of said coupling.

It is a further object of the present invention to provide a secure connection by means of a one piece retaining element comprising one or more leaf spring arms that can be quickly released manually.

Another object of the present invention is to provide a retaining element with one or more leaf spring arms embodying radially outward turned flanges for ease of assembly between the two components.

A more specific object of the present invention is to provide a retaining element that includes extended finger portions of the radially outward turned arms for the quick, manual release of the coupling without special tools.

A further object of the present invention is a means of preventing the axial movement of the retaining element on the male member to assist in assembly.

It is also an object of the present invention to provide an improved means of sealing the quick connector when engaged so as to prevent leakage.

The foregoing objects are accomplished in the preferred embodiment of the invention by a coupling for releasably connecting two fluid conduit lines comprised of a male member, a female member, a retaining element and a sealing means. The male member is formed with an axial bore for the fluid to be conveyed and has a first end with an extending portion that engages with the female member axial bore, and a second end with means for attachment to a fluid line. The female member is formed with a first end having a axial bore for receiving the extending portion of the male member, and a second end having a means for attachment to a fluid conduit line. An annular extending collar portion on the first end with a frustroconical shape provides for a surface to engage with the attachment means. The retaining element is disposed between two annular flanges positioned adjacent to each other upon the male member. It comprises one or more leaf spring arms extending axially from an annular central ring through which the male member extends. The retaining element cooperates with the collar portion on the terminal end of the female member securing the connection. The sealing means is formed by a series of spaced grooves on the extending portion of the male member in which O-rings are positioned to form a seal between the adjacent walls of the male member and the female member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DRAWINGS

The drawings described herein are for illustration purposes only and are not intended to limit the scope of the present disclosure in any way.

FIG. 1 is a partially sectioned view of the coupling of the present invention in the connected condition;

FIG. 2 is a side view of the male coupling end with attached retaining element and O-ring seal;

FIG. 3 is an exploded view of the female coupling end and the retaining element;

FIG. 4 is a perspective view of a variation of the retaining element alone;

FIG. 5 is a partially sectioned perspective view of the male and female couplings in the engaged position;

FIG. 6 is a side view of the male coupling end embodying a one sided retaining element attached;

FIG. 7 is a side view of the male and female members detached with the retaining element in both the engaged and disengaged positions;

FIG. 8 is a partially sectioned side view of the coupled male and female ends with a variation in the retaining element and O-ring position; and

FIG. 9 is a cross-sectional view of the male portion inserted into the female portion with a variation of the female end locking collar.

### DETAILED DESCRIPTION

The following description is merely exemplary in nature and is not intended to limit the present disclosure, application, or uses. It should be understood that throughout the drawings, corresponding reference numerals indicate like or corresponding parts and features.

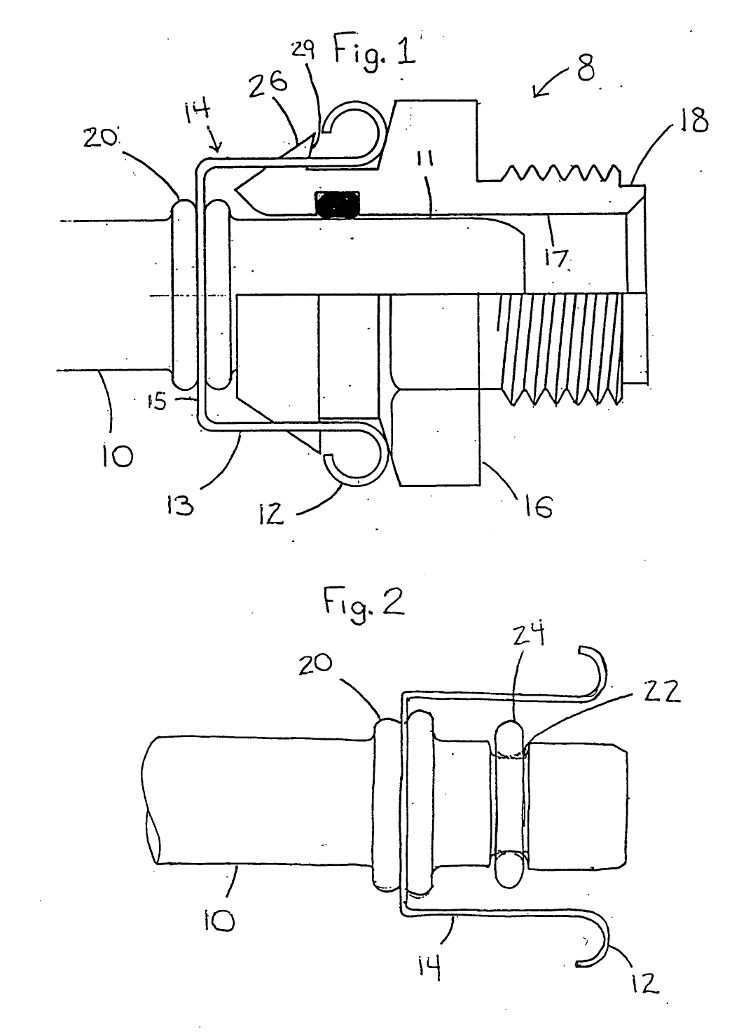

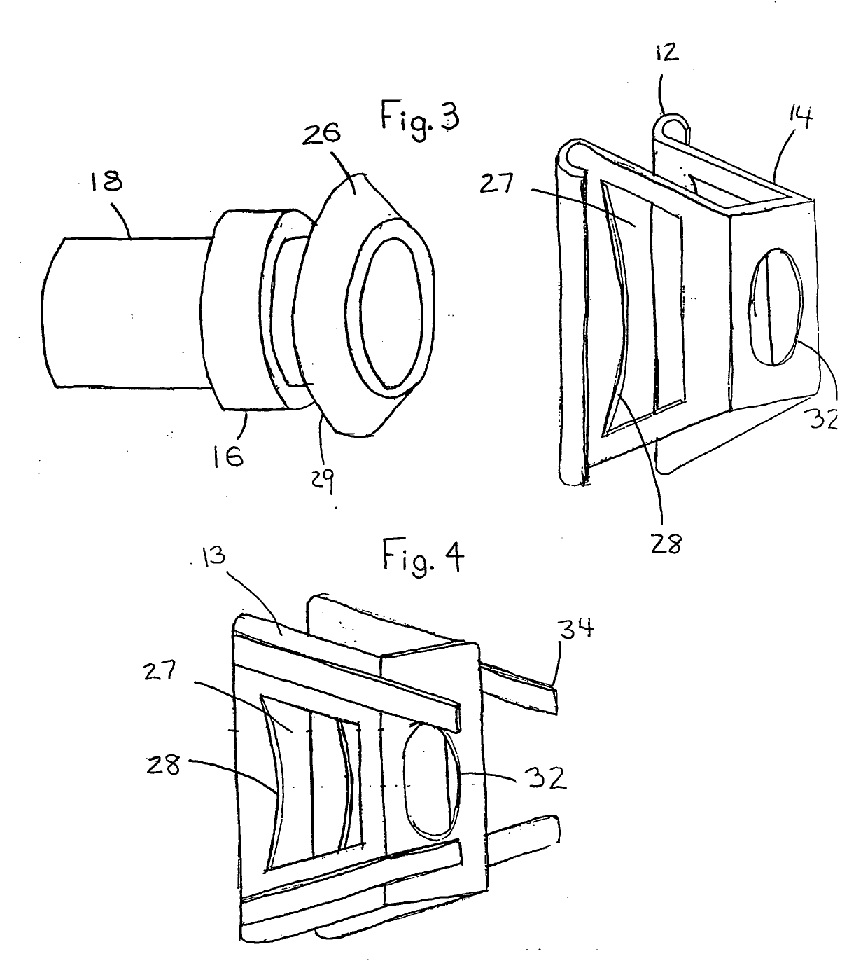

Referring now to the drawings and particularly to FIGS. 1 and 2, there is shown therein the quick connector 8 of the present invention. The coupling is generally comprised of four main portions: the male member 10, the female member 18, the retaining element 14, and a sealing means 24. The male and female ends may attach to any number of types of fluid conduit lines. The male member 10 will consist of an extending portion 11, whose exterior surface will engage with the internal cylindrical bore 17 of the female member 18 when connected. The male member 10 includes a one piece retaining element 14 comprised of one or more leaf spring arms 13 extending axially from an annular central ring 15, through which the male member 10 of the coupling extends. The leaf spring arm is generally U-shaped consisting of a radially outward turned portion 12 for ease of engagement with the frustroconical flange 26 located on the receiving end of the female member 18.

The male member 10 includes a pair of annular beads 20 positioned adjacent to each other on the male member's outer surface, between which the central ring portion 15 of the attached retaining element is positioned, preventing axial movement along the male member 10. The extending portion of the male member has one or more spaced grooves 22 in which O-rings 24 are positioned to seal the connection when engaged. The O-ring(s) 24, span the area between the exterior wall 11 of the extending portion of the male member 10, and the interior wall 17 of the female member. By locating the O-ring(s) within the grooves 22, their axial movement along the extending portion 11 of the male member 10 will be limited during engagement.

During engagement of the male member 10 and the female member 18, the chamfer radius 12 of the leaf spring arms 13 deflect radially upon contact with the frustroconical flange 26 of the female member 18. The leaf spring arm has an attachment window 27 defining an attachment edge 28 located within the plane of its flat shape as seen in FIGS. 3 and 4. Upon full connection between the male member 10 and the female member 18, the leaf spring arms 13 deflect, causing the attachment edge 29 of the tapered flange 26 located on the receiving end of the female member 18 to engage with the window 27, and more specifically, the attachment edge 28 of the leaf spring connector to form a secured connection.

The retaining element 14 is located on the male member and is secured in place by two annular beads 20 on the male member, the position of which ensures that the male member 10 remains in a particular position within the female member 22, as well as preventing retaining element 14 from sliding down male member 10 during engagement. As best shown in FIG. 4, the retaining leaf spring clip 14 has an alternative embodiment in which the leaf spring arms 13 have extending portions of the leaves 34 which, when squeezed manually, can disengage the attachment surface 28 of the retaining leaf spring 14 from attachment edge 29 of the tapered flange 26 located on the receiving end of the female member 18. This embodiment overcomes the need for special tools to release the quick connector.

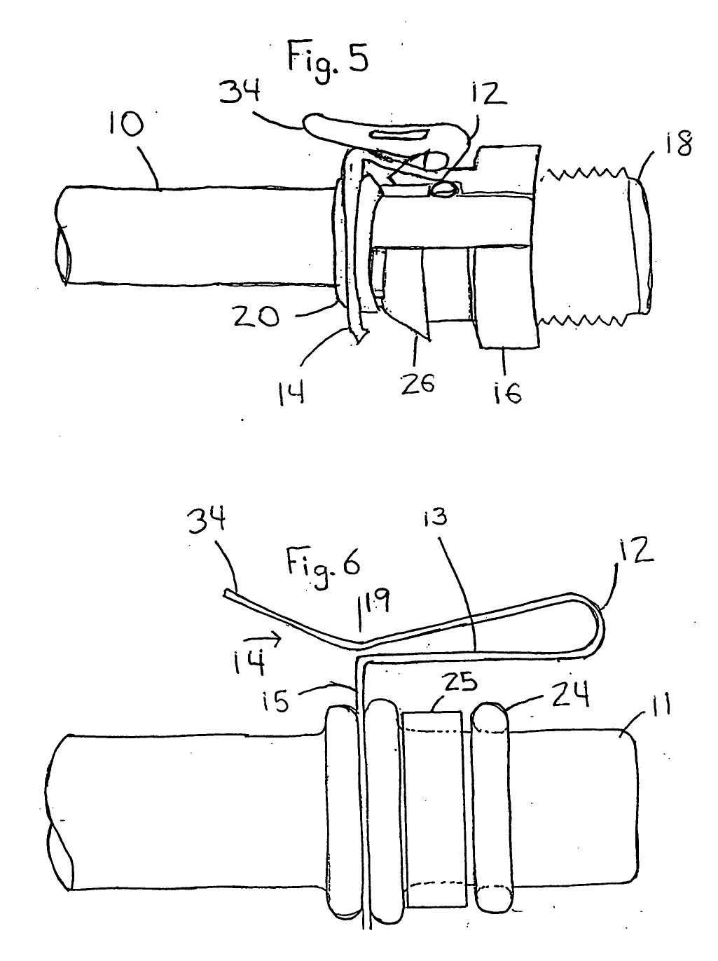

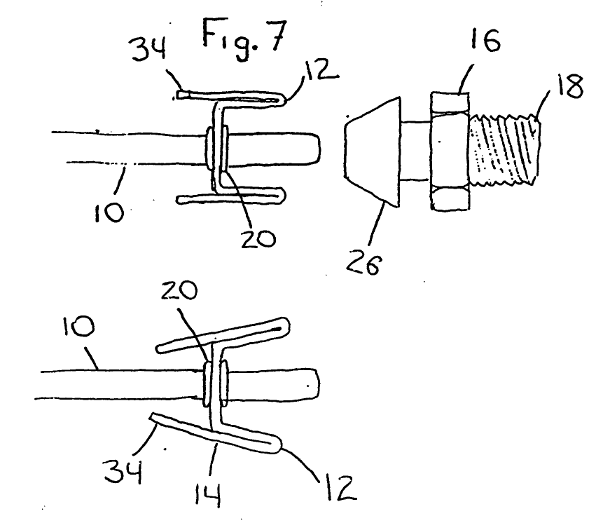

The preferred embodiment shown in FIGS. 5 and 6 shows a retaining leaf spring 14 with a single attachment arm 13, for ease of engagement. The extended portion 34 of the leaf spring is formed by creating a radially outward bend 12 in the leaf spring arm 13 extending back beyond the attachment point axis 19 of the annular central ring 15 of the retaining element 14. FIG. 6 also shows the use of a retainer bushing 25 for control of the male extending member 11 while guiding it into the female receiving bore. FIG. 7 shows the position of the retaining element 14 in both its relaxed disengaged state and the deflected state; whereas pressure is applied to the extending portions 34 of the leaf arms, causing the spring arm 13 to deflect for removing the male member 10 from the female member 18.

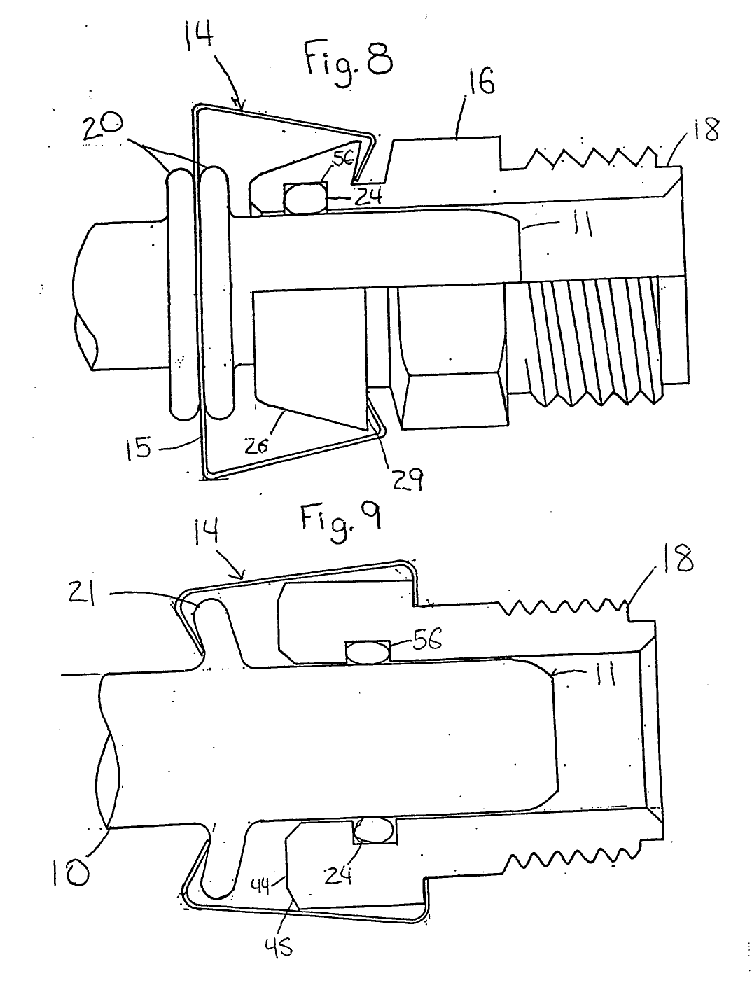

FIGS. 8 and 9, show alternative embodiments to the present invention wherein retaining element 14 has an inward turned arm for attachment to the attachment edge 29 of the tapered flange 26 located on the receiving end of the female member 18. The annular ring portion 15 of the attachment means may still be retained between two annular beads 20 as seen in FIG. 8, or it may be retained by a single flange 21 as seen in FIG. 9.

Furthermore, FIGS. 8 and 9 show the alternative position for the O-ring seal 24 in a groove 56 located on the inside bore of the female member 18 instead of upon the extending portion 11 of the male member 10.

An alternative to a complete frustroconical flange 26 on the female member, FIG. 9 shows a female member 18 with a flange 44 containing two chamferous beveled edges 45 for use in connecting the coupling.

The description of the invention is merely exemplary in nature and, thus, variations that do not depart from the gist of the invention are intended to be within the scope of the invention. Such variations are not to be regarded as a departure from the spirit and scope of the invention.

What is claimed:

1. A swivelable, releasable fluid line coupling comprising:
a male coupling member, said member having two annular beads adjacent one another proximal the end of said male coupling member, defining a coupling portion of the male coupling member;
a female coupling member having a terminal end comprising a frustroconical annular flange disposed around the terminal end defining a attachment edge, and having a central aperture for partially receiving the coupling portion of the mail coupling member there within;
a one piece retaining element, said retaining element comprising a ring disposed around the male coupling member between two adjacent annular beads, said retaining element having at least one deflectable arm extending perpendicular from said ring towards said coupling portion, said at least one arm having an aperture for receiving a portion of said attachment edge of said female coupling member when said male member and said female member are coupled.

2. The releasable fluid line coupling of claim 1 further comprising an annular groove on said coupling portion of said male member for retaining a resilient o-ring to seal against said female coupling member.

3. The releasable fluid line coupling of claim 1 wherein said at least one deflectable arm comprises a radially outward bend for deflecting outwards upon contact with said frustroconical flange during coupling.

4. The releasable fluid line coupling of claim 3 further comprising an annular groove on said coupling portion of said male member for retaining a resilient o-ring to seal against said female coupling member.

5. The releasable fluid line coupling of claim 1 wherein said at least one deflectable arm doubles back past said ring providing a lever to selectively disengage said deflectable arm from said attachment edge of said female member upon biasing said lever inwards radially.

6. The releasable fluid line coupling of claim 5 further comprising an annular groove on said coupling portion of said male member for retaining a resilient o-ring to seal against said female coupling member.
